(19) United States
(12) Patent Application Publication
(10) Pub. No.: US 2023/0150453 A1
(43) Pub. Date: May 18, 2023

(54) SYSTEM AND METHOD FOR DETECTION AND PREVENTION OF RELAY ATTACK ON VEHICLES KEYLESS SYSTEM

(71) Applicant: HARMAN INTERNATIONAL INDUSTRIES, INCORPORATED, Stamford, CT (US)

(72) Inventors: Dror COHEN, Novi, MI (US); Shachar MENDELOWITZ, Novi, MI (US); David MOR, Novi, MI (US); Alexander KREINES, Novi, MI (US)

(73) Assignee: HARMAN INTERNATIONAL INDUSTRIES, INCORPORATED, Stamford, CT (US)

(21) Appl. No.: 17/916,829

(22) PCT Filed: Apr. 6, 2020
(86) PCT No.: PCT/US2020/026889

§ 371 Date: Oct. 4, 2022

(51) Int. Cl. B60R 25/31; G06N 20/00; B60R 25/20

(52) U.S. Cl. CPC B60R 25/31; G06N 20/00; B60R 25/20; B60R 2325/20

(57) ABSTRACT

An access system for a vehicle may include at least one antenna configured to receive access signals for authorization to gain access to the vehicle, and a controller configured to receive motion data from a key fob associated with the vehicle, the motion data indicative of a route of a user associated with the key fob, classify the motion data as one of an open route and a closed route, and restrict access to the vehicle in response to the motion data being classified as an open route.

### TECHNICAL FIELD

Disclosed herein are systems and methods for detection and prevention of relay attack on vehicle keyless systems.

### BACKGROUND

More and more vehicles are including passive entry systems where a key fob may transmit certain frequencies and unlock and lock vehicle doors. These passive entry systems provide for great usability, increase customer satisfaction, and vehicle theft protection. However, as the capabilities of these keyless systems increase, the range at which a vehicle may detect a key fob increases, which in turns created greater opportunities for the entry systems to become vulnerable to relay attacks.

### SUMMARY

An access system for a vehicle may include at least one antenna configured to receive access signals for authorization to gain access to the vehicle, and a controller configured to receive motion data from a key fob associated with the vehicle, the motion data indicative of a route of a user associated with the key fob, classify the motion data as one of an open route and a closed route, and restrict access to the vehicle in response to the motion data being classified as an open route.

A method for a vehicle access system may include receiving motion data from a key fob associated with a vehicle, the motion data indicative of a route of a user associated with the key fob, classifying the motion data as one of a plurality of route types by comparing the motion data with previously classified motion data, the plurality of route types including an open route type and a closed route type, and updating a classification database with the motion data and associated route type for classification of other motion data.

An access system for a vehicle, may include a memory configured to maintain motion data associated with a route classification, a controller in communication with the memory and configured to receive motion data generated by a sensor within key fob associated with the vehicle, the motion data indicative of a route of the key fob, classify the motion data as one of an open route and a closed route, and restrict access to the vehicle in response to the motion data being classified as an open route.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an exploded view of a display system in accordance with one embodiment;

FIG. 2 illustrates an example diagram of a relay attack scenario;

FIG. 3A illustrates an example route similar to that of FIG. 2, where a user returns to the vehicle;

FIG. 3B an example of route where the user does not return to the vehicle;

FIG. 4 illustrates an example system where the key fob includes a sensor, database authenticator, and classifier.

FIG. 5 illustrates another example system where the key fob includes the sensor and database, and the vehicle includes the authenticator and classifier;

FIG. 6 illustrates another example system where the key fob includes the sensor, database, and classifier, and the vehicle includes the authenticator,

FIG. 7 illustrates another example system where the key fob includes the sensor and the server includes the database, authenticator, and classifier; and

FIG. 8 illustrates an example process for the access system of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is an advanced relay attack prevention system for passive entry vehicle systems. As vehicle technologies advance, new features such as hands free access and ignition of the vehicle are becoming more and more prevalent, as well as expected by customers. These passive systems often rely on the authentication of a key fob which transmits frequency responses to a vehicle and is authenticated based on the frequency response of the specific key fob.

However, with this technology comes additional challenges to an expanding attack surface. As a user approaches or leaves a vehicle, the frequency responses may be copied or spoofed by a cloning device and used to gain access to the vehicle. A relay attack may involve two stations placed in distinct physical locations. The first location may be within proximity to the target vehicle. The second location may be obscured or hidden, within proximity of the key fob associated with the target vehicle. A thief at the second location may operate a specialized radio frequency device for large distance radio frequency bidirectional communication. The key fob signal may be copied and relayed by the device at the second location to the first location near the target vehicle. A similar device at the first location may receive the signal and unlock the vehicle by spoofing the original key fob signal. This may allow a thief at the first location to gain access to the vehicle.

Relay attacks typically take place in one of two scenarios. First, a key fob may be stationary at a user's home, office, etc. The attackers may communicate with the key fob and copy signals through walls, doors, windows or the like. The second scenario, the key fob may be in motion, typically carried by the owner, away from his or her vehicle. The attacker may follow the owner in a public parking lot and communicate with the key fob while the owner is on the move. In each of these scenarios, the attackers may manage to relay signals form the key fob to the vehicle, bridging the physical gap by special transmission equipment and causing the vehicle to unlock, and possibly, trigger the ignition.

Existing defenses against the first scenario have been developed. In one example, traditional communication level protection for better distance bounding may be used, such as ultra-wideband (UWB). Another example solution may include putting a stationary fob into a dormant mode where the key fob fails to transmit any signals when the key fob is stationary. Other systems may increase encryption, limit a vulnerability window for signal transmission, etc. However, these solutions do not eliminate the systems susceptibility for attacks but simply narrow the opportunities. In the event of the second scenario, where the owner is moving with the key fob, many of these mechanisms are ineffective.

Thus, described herein is an access system that uses motion data from the key fob to predict the route classification of the key fob to determine whether the vehicle access attempt is legitimate or fraudulent. Under normal circumstances, the owner typically parks his or her car, and walks away from the car. The vehicle may recognize a spoofed signal if a strong signal is received after the owner has walked away from the vehicle. However, in the case where the owner returns to the vehicle to fetch something from it, the vehicle may not be able to differentiate this legitimate signal from an illegitimate one. To combat this issue, the disclosed system may determine whether the owner has returned to the vehicle or not. If not, then the signal may be deemed unauthorized. In predicting the assumed route of the key fob, the system may determine whether it was the key fob that transmitted the signal, or an otherwise unauthorized signal that was spoofed. That is, a normal scenario is discerned from an attack scenario.

Raw motion data generated by the key fob may be processed and a route classification predicted based on the motion data. The access to the vehicle may be permitted based on this classification. As more and more data is collected, machine learning may formulate and recognize data typical of certain routes. In the example of the owner returning to the vehicle, the data may indicate a circular-like route. This route may be predicted based on the motion data from the sensor within the fob, such as acceleration, gyration, etc. Accordingly, a more accurate and secure anti-attack access system is described herein where legit attempts to access a vehicle are discernable from spoofed relay attacks.

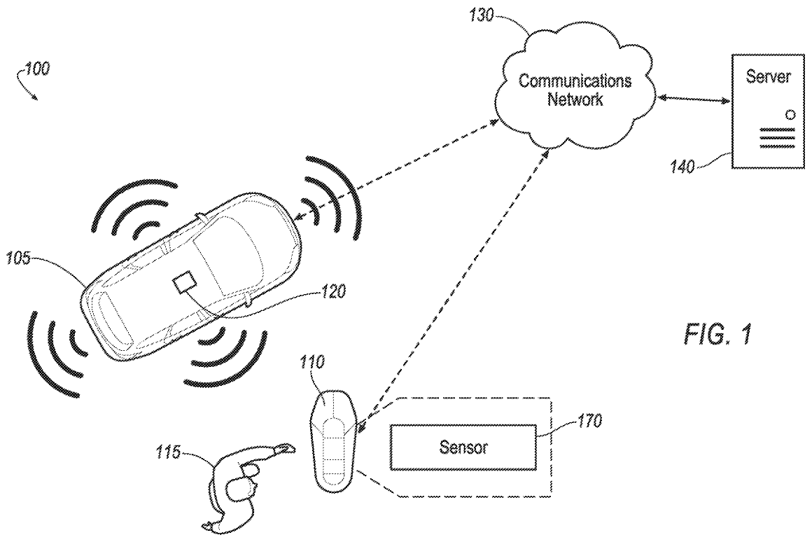

FIG. 1 illustrates an example access system 100 for a vehicle 105 including a key fob 110 configured to authenticate a user to allow access to the vehicle 105. The key fob 110 may be any smart key having a transmitter configured to transmit low frequency signals (e.g., 315 MHz for vehicles in North America and at 433.92 MHz for various vehicles in Europe and Asia) and is typically carried and associated with an authorized user/driver 115 of the vehicle 105. Additionally or alternatively, the key fob may be a user's personal device such a mobile device, where the phone is the key.

The vehicle 105 may include at least one antenna 120 configured to transmit low frequency challenges. These low frequency challenges may be transmitted at predefined increments or based on a keyless entry action such as approaching the vehicle, leaving the vehicle, touching a door handle, etc. The key fob 110 may respond with a low frequency response. The antenna 120 may receive these access signals and, in response to recognizing the low frequency response, the vehicle 105 may perform an authorized action, such as unlock, lock, start the vehicle ignition, etc. While a single antenna 120 is shown in FIG. 1, more than one antenna may be arranged around and within the vehicle to increase reception of the access signals.

The key fob 110 may include at least one sensor 170 configured to detect motion of the key fob. In one example, the sensor 170 may be a microelectromechanical system (M EMS) sensor, or other electrical-mechanical sensors. The sensor may include other motion sensors such as accelerometers, gyroscopes, magnetic field sensors, gravity sensors, calculated rotation vectors, etc.

The vehicle 105 may include a vehicle controller, such a vehicle electronic control unit (ECU) and memory. The controller and memory may be configured to maintain and operate vehicle functions related to the operation of the vehicle, including passive entry operations such as unlock, lock, etc. The controller may also receive indications of when the vehicle has been locked, as well as other status information associated with the vehicle 105, such as key on, brake, etc. The controller may include an authenticator and classifier as described in more detail below. The controller may be in communication with the antenna 120 and may receive the access signals from the antenna for authentication.

The vehicle 105 and/or the key fob 110 may communicate with a communications network 130. The communications network 130 may provide communications services, such as packet-switched network services (e.g., Internet access, VoIP communication services, vehicle to vehicle, over the air, etc.), to devices connected to the communications network 130. An example of a communications network 130 may include a cellular telephone network, other networks that facilitates wireless communication.

A server 140 may be external or internal to the vehicle or another structure. The server 140 may also be a cloud-based server. The server 140 may include multiple devices or processors, as well as include storage mediums, applications, transceivers, etc. The server 140 may include or be in communication with the vehicle 105 and/or the key fob 110. The server 140 may maintain a database, such as a motion database, configured to maintain raw motion data provided by the key fob sensor. This is described in greater detail herein. The motion data may be transmitted via the communications network 130 to the server 140 directly from the key fob 110. Additionally or alternatively, the data may be transmitted via the vehicle 105.

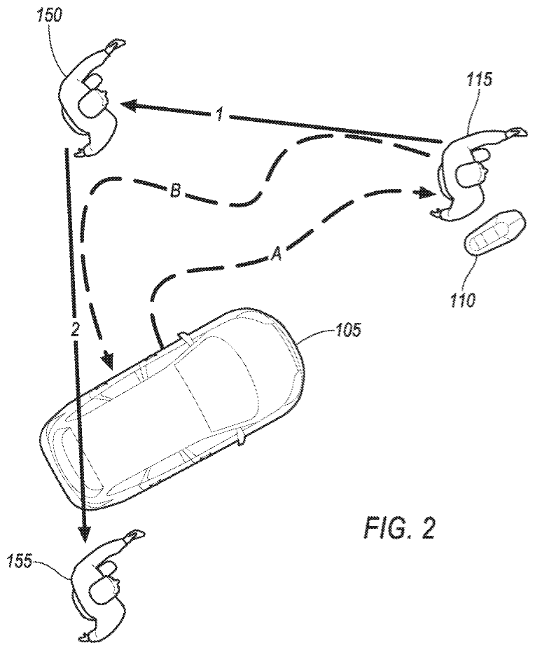

FIG. 2 illustrates an example diagram of an attack scenario. A typical use of passive entry systems is that when the user 115 parks his or her vehicle 105, the user 115 may exit the vehicle and walk to his or her destination. This is shown in FIG. 2 as path A. The passive entry system may then lock the vehicle as the user 115 walks away from the vehicle 105. The locking may be done automatically, or upon activation of a button on the key fob 110 by the user 115. In another example, after the user 115 walks away from the vehicle along path A, the user 115 may return to the vehicle along path B. This may be for any reason, including that the user forgot an item in the vehicle 105, wanted to return an item to the vehicle, etc. During the user's travel along paths A and B, the key fob 110 may continue to transmit low frequency responses. As explained, these responses are vulnerable to being copied, spoofed, etc., by thieves or attackers.

Relay attacks may occur when more than one unauthorized user manages to relay the signals from a key fob to the vehicle, via special transmission equipment, causing the vehicle to believe that the key fob is in the vicinity and thus, allow access to the vehicle 105. In the example shown in FIG. 2, a first unauthorized user 150 may be in a vicinity of the authorized user 115. The first unauthorized user 150 may have a frequency copier device and may copy the signal transmitted by the key fob 110 as the authorized user 115 travels along either of paths A or B. A second unauthorized user 155 may be located in close proximity to the vehicle 105 and may also have a frequency copier device. The copier device associated with the second user 155 may copy frequencies from the copier device associated with the first unauthorized user 150. The second unauthorized user 155 may then use the copied frequencies to gain access to the vehicle.

The system 100 of FIG. 1 aims to prevent this scenario from happening by detecting motion and using motion data from the key fob 110 to determine a route of the user 115, and when and if the user 115 is returning to the vehicle 105.

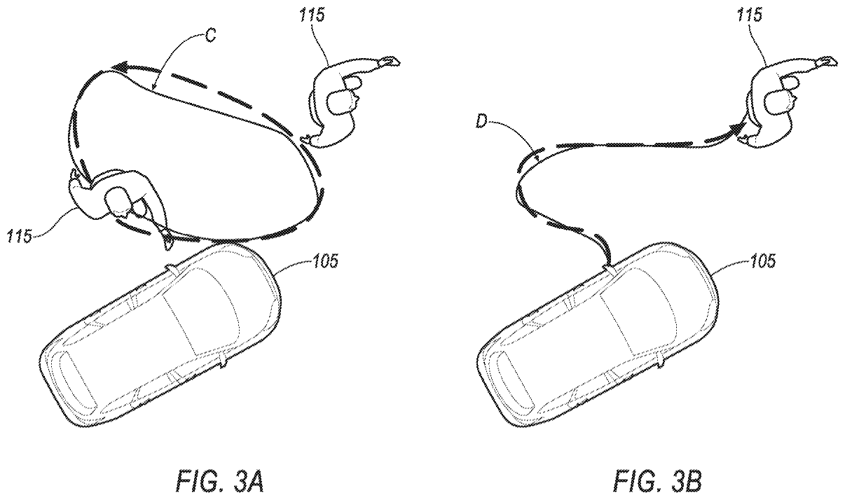

FIGS. 3A and 3B illustrate example routes taken by the user 115. FIG. 3A illustrates an example closed loop route C similar to the combination of both of paths A and B of FIG. 2, where the user 115 leaves the vehicle, but shortly returns. The key fob 110 may provide motion data indicative of route A.

FIG. 3B illustrates an example open loop route D similar to that of path A of FIG. 2, where the user 115 leaves the vehicle 105. The key fob 110 may provide motion data indicative of route D in this example.

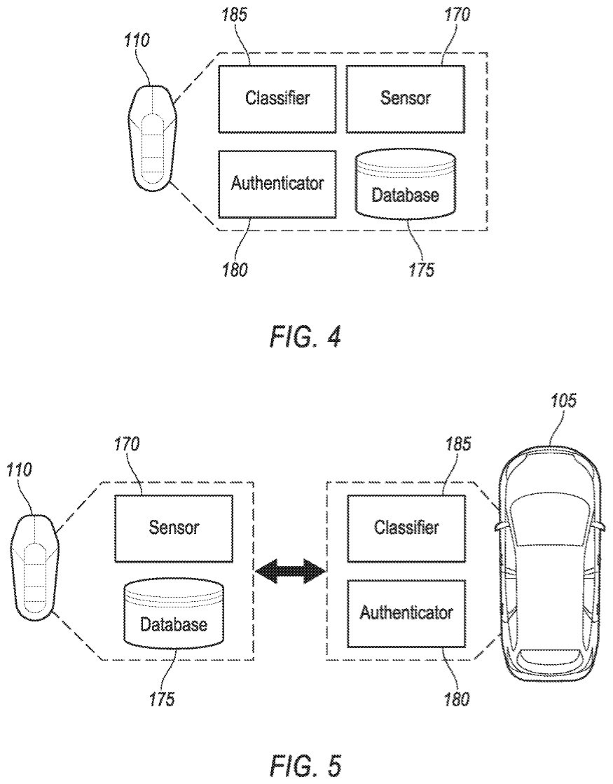

FIGS. 4-7 illustrate example access systems of FIG. 1 where the processing and storage are performed in various capacities by each of the key fob 110 and the vehicle 105. Referring generally to FIGS. 4-7, the key fob 110 may include the sensor 170. As mentioned above, the sensor 170 may be one or more of a MEMS sensor, accelerometer, gyroscope, or any electronic device capable of detecting motion. The sensor 170 may produce raw motion data in response to any motion at the key fob 110.

A motion database 175 may be configured to receive and maintain the raw motion data generated by the key fob 110. An authenticator 180 may be a controller configured permit certain signals to be received or transmitted for vehicle access. For example, in the event that an unauthorized signal is received, the authenticator may determine whether to unlock the vehicle in response to the signal.

A classifier 185 may be a controller configured analyze the raw motion data from the motion database 175. In the example of the classifier 185 being arranged in the vehicle, the controller may be the ECU. In the example of the classifier being part of the key fob 110 or server 140, the classifier 185 may be a special purpose processor or controller configured to carry out the instructions herein. The classifier 185 may use the motion data to classify that route. The predicted route classification may indicate whether the user has returned to the vehicle, as shown in FIG. 3A, or whether the user has continued to move away from the vehicle, as shown in FIG. 3B. The classifier 185 may look at various aspects, sequences, and combinations of the raw data, such as timestamps, speed, gyration, angular velocity, acceleration, etc. Notably, the motion data is not based upon a satellite or geofencing data such as global positions system data or the like. Instead, a predicted route classification, is generated.

The classifier 185 may classify the route has a route type. The route type may in turn indicate the status or authorization for unlocking or allowing access to the vehicle 105. In one example, the route type may be one of an open route, or a closed route. The closed route type may indicate a return of the user 115 to the vehicle 105 and thus the classifier/controller may instruct the vehicle to authorize (i.e., unlock the vehicle) in response to receiving an access signal. Conversely, when an access signal is received when the route type is an open route, the controller may instruct the vehicle 105 to not authorize any access signals.

Additionally, the classifier 185 may, over time, generate stacks of data that indicate a closed loop route (e.g., FIG. 3A) and an open loop mute (e.g., FIG. 3B). The classifier 185, because of the iterative learning, may train itself to recognize certain raw data as being indicative of the various types of routes, such as opened and closed. That is, a group of data may be equalized and classified accordingly. Once a set of motion data has been analyzed and associated with a route type, that association may be saved in a classification database for future use by the machine model for training and updating. This classification database may be integrated into database 175 or may be a separate database. In the latter example, the database may be arranged at the server 140 in order to increase computation capabilities as well as appreciate an increase in encryption and security.

The machine learning may be based on the evaluation of sequential motion data by a fully supervised or semi-supervised learning model. The training data may be composed of a database of normal raw data when drivers lock their vehicles and return shortly thereafter, creating enclosed trajectories. The training data may also be composed of a database of normal raw data when drivers lock their vehicles and fail to return shortly thereafter, creating opened trajectories. The model is trained and evaluated, on the entire dataset, in order to facilitate the machine learning classification that is able to distinguish between open and closed routes. Statistical inferences may be used to further secure the key fob and differentiate between attackers and legitimate access signals from the key fob.

In one example, where the controller determined that the motion data indicated a closed route, the controller may receive verification that this determination was accurate. This may occur by verifying that the user did indeed return to the vehicle 105. In one example, this verification may be achieved by confirming that the user unlocked the vehicle on his or her return to the vehicle. Such confirmation may also be achieved by comparing the route to GPS data from the user's mobile device or the like.

The classifier 185 may provide the route classification to the authenticator 180 so that the authenticator may determine whether or not to permit access to the vehicle 105. In some examples, where the authenticator 180 and the classifier 185 are arranged in the same component, e.g., both in the key fob 110, both in the vehicle 105, or both in the server 140, the authenticator 180 and classifier 185 may be the same controller. Regardless, the classifier 185,

The classifier 185, authenticator 180, and database 170 may be embodied in a hardware system such as a computing platform. As explained, each of these elements may include or be part of one or more processors configured to perform instructions, commands and other routines in support of the processes described herein. Computer-readable mediums (also referred to as a processor-readable medium or storage) include any non-transitory medium (e.g., a tangible medium) that participates in providing instructions or other data that may be read by the processor of the computing platform. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Referring to FIG. 4, in this example, the key fob 110 may include each of the database 175, authenticator 180, and the classifier 185. In this example, the key fob 110 itself may determine whether to transmit a signal to the vehicle. If the classifier 185 does not determine that the motion data indicates a closed loop, then the classifier 185 may instruct the key fob 110 to cease signal transmissions, similar to a dormant mode.

FIG. 5 illustrates an example where the sensor 170 and database 175 are maintained in the key fob 110 while the authenticator 180 and the classifier 185 are maintained in the vehicle 105. In this example, the database 175 may transmit the raw data to the classifier 185 via the authenticator 180 for processing. The classifier 185 may in turn classify a route based on the motion data and the authenticator 180 may determine, based on that classification, whether or not to respond to received signals.

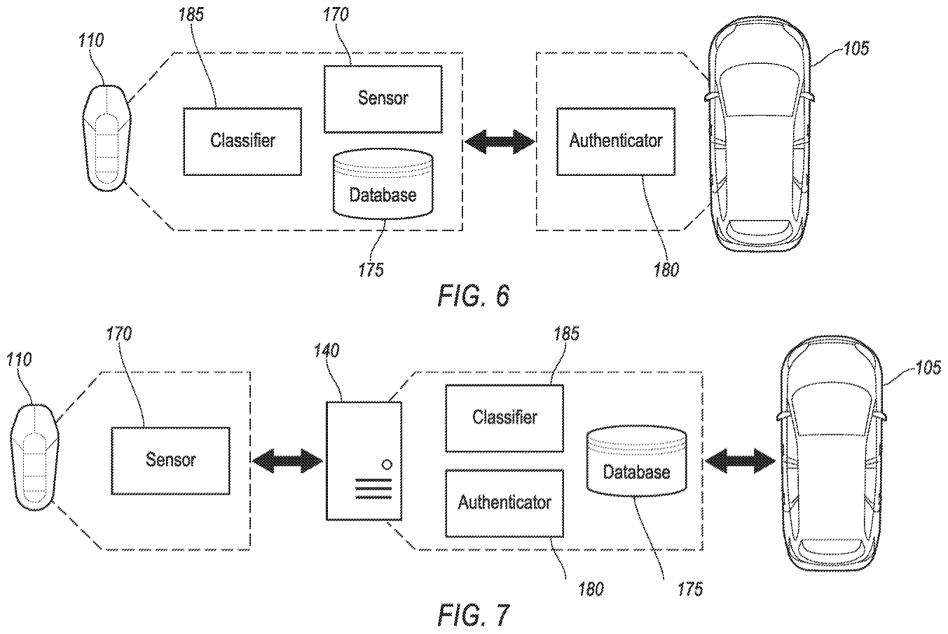

FIG. 6 illustrates an example where the classifier 185 is arranged in the key fob 110 and sends the classification to the authenticator 180 at the vehicle 105.

FIG. 7 illustrates an example where the database 175, authenticator 180, and classifier 185 are at the server 140 and the motion data is transmitted over the communication network 135 (as shown in FIG. 1), to the server 140 for processing. The server 140 may then return instructions to the vehicle 105 to indicate whether or not access signals should be taken at legitimate. This example may have the key fob 110 communicate directly with the server instead of the vehicle. In this example, additional degrees of security may be achieved, as well as more computation power.

Although FIGS. 4-7 illustrate various examples of the components, duplicative components may be included in a single system but across multiple devices. For example, both the vehicle and the key fob may include an authenticator. Databases may be included in one, two or three of the key fobs 110, vehicle 105 and server 140. Various combinations and arraignments of components may be appreciated.

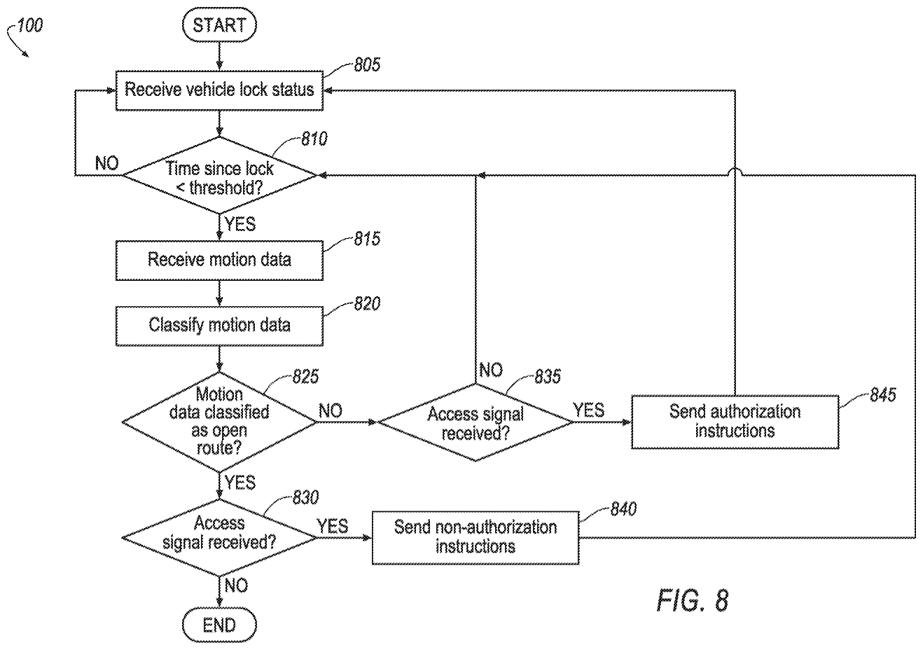

FIG. 8 illustrates an example process 800 for the access system 100. The process 800 begins at block 805 where the controller may receive the vehicle lock status. This indicates that the vehicle is currently locked.

At block 810, the controller may determine whether the vehicle has been locked for a predefined time threshold. In one example, the time threshold may be approximately two minutes. This may be a reasonable time to allow a user to return to his or her vehicle 105 to acquire a forgotten item. If the time threshold has not been exceeded, the process 800 proceeds to block 815. If not, the process 800 returns to block 805.

At block 815, the controller may receive motion data from the motion database 175. The motion data, as explained, my include data acquired form the sensor 170 within the key fob 110.

At block 820, the controller may process and classify the motion data. As explained above, this classification may include comparing the data to known routes with similar data in an effort to determine a path taken by the user 115. The classification may also include updating the classification database with the new motion data and associated classification to update training data for future classifications.

At block 825, the controller may determine whether the data was classified as an open route. As explained, an open route indicates a non-circular route by the user 115, indicating that the user 115 has not returned to the vehicle 105. If so, the process 800 proceeds to block 830. If not the process 800 proceeds to block 835.

At block 830, the controller may determine whether an access signal was received via the vehicle antenna 120. As explained above, an access signal is an indication of an attempt for vehicle access via the passive entry system. If an access signal was received, the process 800 proceeds to block 840. If not, the process 800 ends.

At block 840, the controller may transmit non-authorization instructions to the appropriate vehicle systems, such as the locks, etc. This may be in response to the classification indicating an open loop in which the user 115 did not return to the vehicle 105. Because an access signal was received without the user 115 returning to the vehicle 105, it may be determined that the access signal is an unauthorized signal. In response to an unauthorized signal being received, the controller may instruct the vehicle to issue an alert, such as sounding the vehicle's alarm, sending a notification to the user's mobile device, etc. The process 800 may then proceed back to block 810.

At block 835, the controller may determine whether an access signal was received via the vehicle antenna 120. If so, the process 800 proceeds to block 845. If not, the process 800 proceeds to block 810.

At block 845, the controller may transmit authorization instructions to the appropriate vehicle system, such as the locks. This may be in response to the classification indicating that the route was not an open loop, or rather a closed loop, in which the user 115 returned to the vehicle 105. Because an access signal was received as the user returned to the vehicle, it may be determined that the access signal is an authorized one (e.g., came from the user 115). The process 800 may then proceed back to block 805 and await a lock status.

Accordingly, a vehicle access system with an increased defense again relay attacks is described. By using MEMs measurements from key fobs, relay attacks may be thwarted even when the distance bounding protocol is circumvented. The system may be implemented entirely on the key fob, which may be appealing for customers as minimal changes to the vehicle system would be required. This may also reduce overall integration, as well as part, costs.

The embodiments of the present disclosure generally provide for a plurality of circuits, electrical devices, and at least one controller. All references to the circuits, the at least one controller, and other electrical devices and the functionality provided by each, are not intended to be limited to encompassing only what is illustrated and described herein. While particular labels may be assigned to the various circuit(s), controller(s) and other electrical devices disclosed, such labels are not intended to limit the scope of operation for the various circuit(s), controller(s) and other electrical devices. Such circuit(s), controller(s) and other electrical devices may be combined with each other and/or separated in any manner based on the particular type of electrical implementation that is desired.

It is recognized that any controller as disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any controller as disclosed utilizes any one or more microprocessors to execute a computer-program that is embodied in a non-transitory computer readable medium that is programmed to perform any number of the functions as disclosed. Further, any controller as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware based inputs and outputs for receiving and transmitting data, respectively from and to other hardware based devices as discussed herein.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An access system for a vehicle, comprising:
at least one antenna configured to receive access signals for authorization to gain access to the vehicle;
a controller configured to
receive motion data indicative of a route of a user associated with a key fob associated with the vehicle,
classify the motion data as at least one of an open route and a closed route, and
restrict access to the vehicle in response to the motion data being classified as an open route.

2. The system of claim 1, wherein the classifying of the motion data includes using a learning model trained on previously collected motion data indicative of certain route types.

3. The system of claim 2, wherein the controller is further configured to update the learning model with accumulated motion data and associated classifications.

4. The system of claim 1, wherein the classifying of the motion data includes comparing the motion data to previously stored data indicative of a certain route type.

5. The system of claim 1, wherein the controller is arranged in one of the key fob or the vehicle.

6. The system of claim 1, wherein the motion data includes acceleration measurements of the key fob.

7. The system of claim 1, wherein the motion data includes angular velocities of key fob movements.

8. The system of claim 1, wherein the motion data includes magnetic field measurements of the key fob.

9. A method for a vehicle access system, comprising:
receiving motion data from a key fob associated with a vehicle, the motion data indicative of a route of a user associated with the key fob,
classifying the motion data as one of a plurality of route types by applying a learning model for prediction of route type of the motion data, the route type including one of an open route type and a closed route type, and
updating a classification database and a learning model with the motion data and associated route type respectively.

10. The method of claim 9, wherein the classifying of the motion data includes using a learning model trained on previously collected motion data indicative of certain route types.

11. The method of claim 9, wherein the motion data includes acceleration measurements of the key fob.

12. The method of claim 9, wherein the motion data includes magnetic field measurements of the key fob.

13. The method of claim 9, wherein the motion data includes rotation vectors of key fob movements.

14. The method of claim 9, further comprising restricting access to the vehicle in response to the motion data being classified as an open route.

15. The method of claim 9, further comprising granting access to the vehicle in response to the motion data being classified as a closed route.

16. An access system for a vehicle, comprising:
a memory configured to maintain a learning model for predicting a route type and motion data associated with a route classification;
a controller in communication with the memory and configured to
receive motion data generated by a sensor within a key fob associated with the vehicle, the motion data indicative of a route of the key fob,
classify the motion data as one of an open route and a closed route, and
restrict access to the vehicle in response to the motion data being classified as an open route.

17. The system of claim 16, wherein the classifying of the motion data includes using the learning model trained on previously collected motion data indicative of a route type.

18. The system of claim 16, wherein the controller is further configured to update the learning model within the memory with at least one of the motion data and associated classification.

19. The system of claim 16, wherein the controller is further configured to update a classification database within the memory with accumulated motion data and associated classifications.

20. The system of claim 16, wherein the motion data includes rotation vectors of key fob movements.
